(19) United States
(12) Patent Application Publication
(10) Pub. No.: US 2015/0263458 A1
(43) Pub. Date: Sep. 17, 2015

(54) ELECTRICAL CONNECTOR PROVIDING PROTECTION TO SOLDERING PORTIONS OF THE CONTACTS

(71) Applicant: FOXCONN INTERCONNECT TECHNOLOGY LIMITED, Grand Cayman (KY)

(72) Inventor: JING-JIE GUO, Kunshan (CN)

(21) Appl. No.: 14/656,021

(22) Filed: Mar. 12, 2015

(30) Foreign Application Priority Data
Mar. 12, 2014 (CN) 201410088596.5

(51) Int. Cl. H01R 13/6581; H01R 43/20; H01R 12/71

(52) U.S. Cl. CPC H01R 13/6581; H01R 12/716; H01R 43/205

(57) ABSTRACT

An electrical connector (100) includes an insulative body (1), a metal shell (3) covering the insulative body for defining a receiving space, a number of contacts (2) retained in the insulative body, and a metal plate (4). The metal plate has a main portion (41) fixed to the metal shell and a seamless cap portion (42) extending backwardly and downwardly from the main portion. Each contact includes a contacting portion (21) extending into the receiving space, a retaining portion (22) extending backwardly from the contacting portion for being retained with the insulative body, and a soldering portion (23) extending backwardly from the retaining portion and outside of the insulative body. The cap portion suspends over the soldering portions of the contacts for providing protection.

### BACKGROUND OF THE INVENTION

1. Field of the Invention

The present invention relates generally to an electrical connector, and more particularly to an electrical connector providing much more protection to soldering portions of the contacts.

2. Description of Related Arts

China Utility Model Pat. No. 202856022 issued on 2013 Apr. 03 discloses an electrical connector comprising an insulative housing, a plurality of contacts retained in the insulative housing, a metal shield covering the insulative housing for defining a receiving space, an insulative cover molded over the insulative body and the metal shield, and a metal plate retained below the insulative cover for assembling the electrical connector onto a printed circuit board. The contacts have a plurality of soldering portions extending out of the insulative cover for being soldered with the printed circuit board and a plurality of contacting portions extending into the receiving space for connecting with a mating plug connector. The metal plate forms a rear arcuate portion extending upwardly to be located above the soldering portions of the contacts for providing protection to the soldering portions of the contacts. However, the rear arcuate portion of the metal plate provides limited protection to the soldering portions because much of the soldering portions are still exposed to ambient.

U.S. Pat. No. 8,777,666 issued on 2014 Jul. 15 discloses a connector module including a connector along with a metal shield can and various encapsulants, such as ground pad encapsulant, that protect the electronic components and other portions of connector from moisture. The metal shield can including two halves that are identical and are machined from, for example, stainless steel, is attached to a ground ring and a substrate. Module may be formed by starting with plug connector and encapsulating all the various electronic components formed on the substrate with a first liquid encapsulant that will seal the components and protect them from moisture and other environmental components. A second encapsulation step then covers the soldered legs and ground pads with a liquid encapsulant that will further seal the connector module to protect it from moisture and other environmental components. The liquid encapsulant may be applied over each side of substrate to fully cover ground pads and shield can legs. Encapsulant is a UV/moisture curably acylate polymer applied in jet dispense operation over each side individually. The polymer is then cured to form a substantially rectangular block of encapsulant that fully encases ground pads and a bottom portion of legs.

An electrical connector providing more protection to soldering portions of the contacts is desired.

### SUMMARY OF THE INVENTION

Accordingly, an object of the present invention is to provide an electrical connector providing much more protection to soldering portions of the contacts.

To achieve the above object, an electrical connector includes an insulative body, a metal shell covering the insulative body for defining a receiving space, a number of contacts retained in the insulative body, and a metal plate. The metal plate has a main portion fixed to the metal shell and a seamless cap portion extending backwardly and downwardly from the main portion. Each contact includes a contacting portion extending into the receiving space, a retaining portion extending backwardly from the contacting portion for being retained with the insulative body, and a soldering portion extending backwardly from the retaining portion and outside of the insulative body. The cap portion suspends over the soldering portions of the contacts for providing protection.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical connector and a printed circuit board which the electrical connector is assembled to constructed in accordance with the present invention;

FIG. 2 is similar to FIG. 1, but taken from a different view;

FIG. 3 is a perspective, exploded view of FIG. 1;

FIG. 4 is similar to FIG. 3, but taken from a different view; and

FIG. 5 is a rear elevational view of FIG. 1.

### DETAILED DESCRIPTION OF THE PREFERRED EMBODIMENT

Reference will now be made in detail to the preferred embodiment of the present invention.

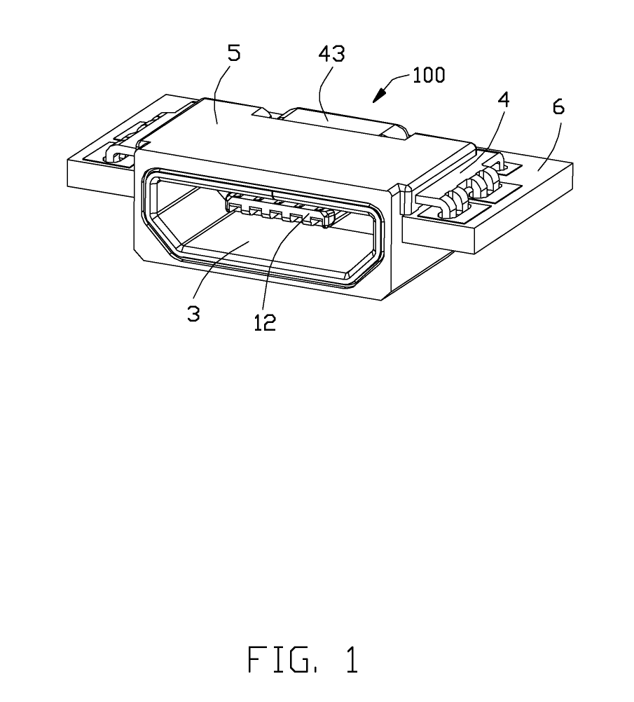

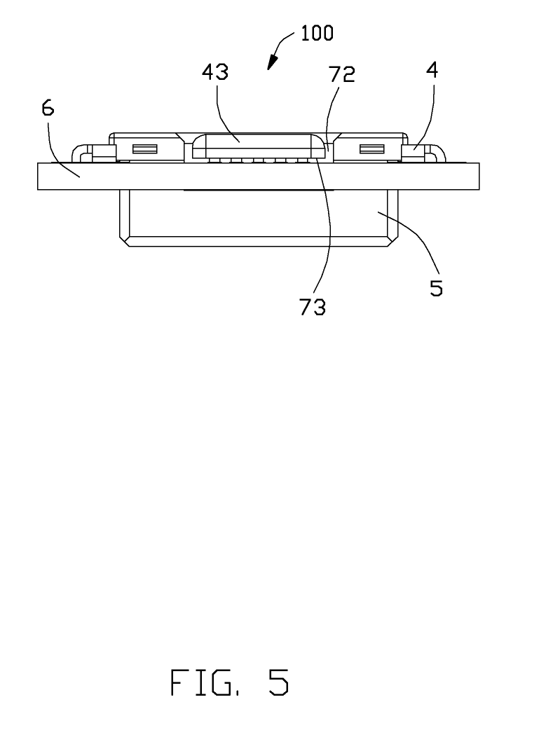

Referring to FIGS. 1-5, an electrical connector 100 of the present invention, assembled on a printed circuit board 6, comprises an insulative body 1, a plurality of contacts 2 retained in the insulative body 1, a metal shell 3 covering the insulative body 1 for defining a receiving space 30, a metal plate 4 fixed to an upper face of the metal shell 3, and an insulative cover 5 insert-molded over the insulative body 1, the contacts 2, the metal shell 3, and the metal plate 4.

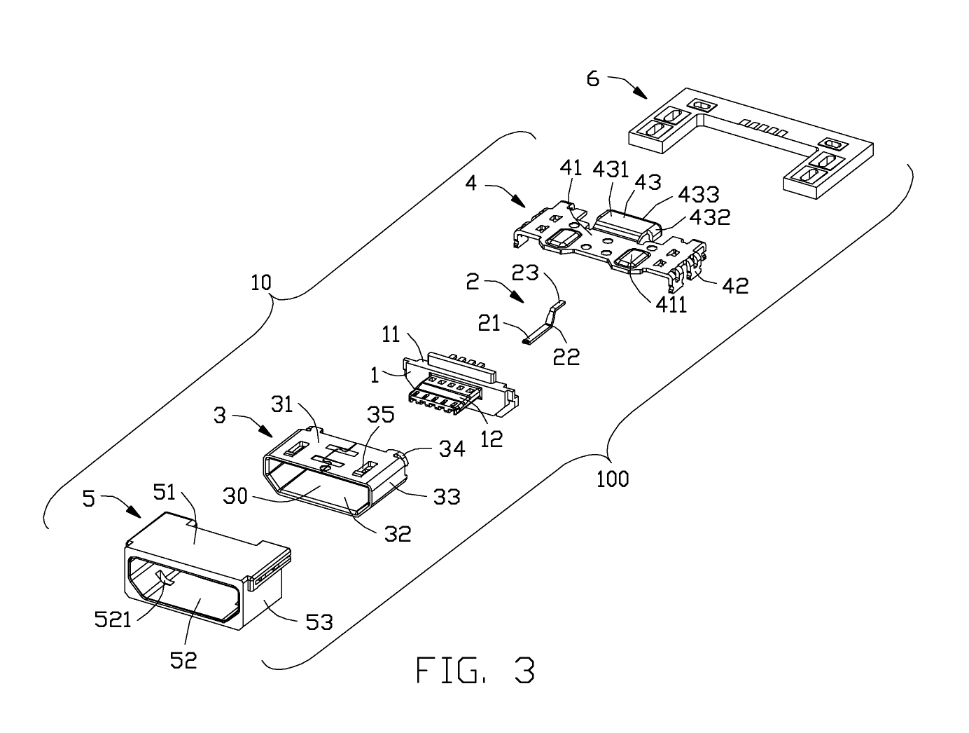

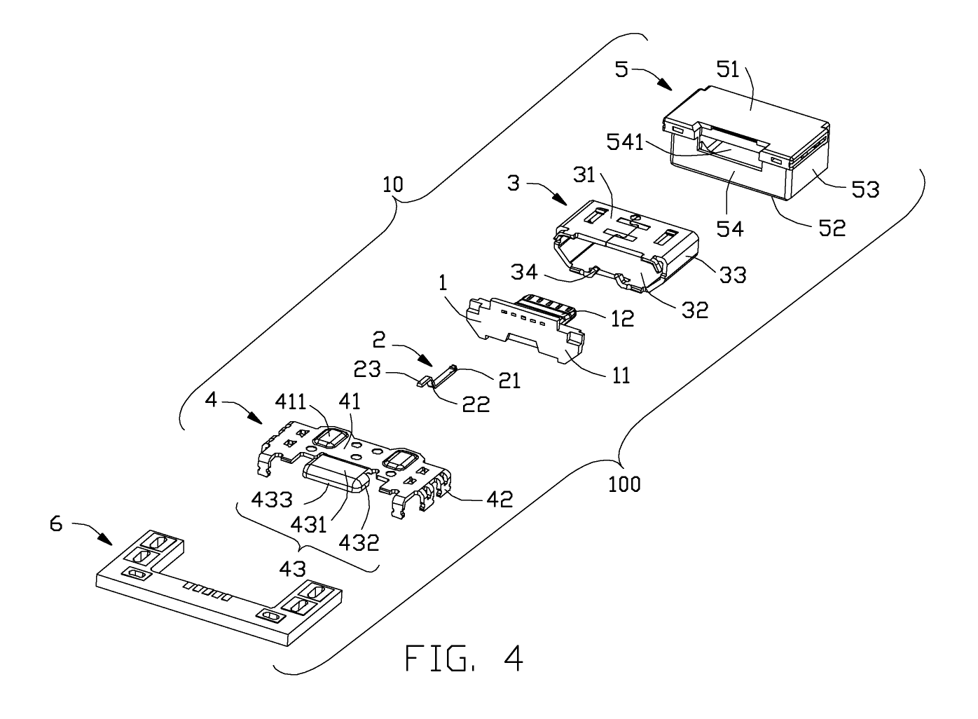

Referring to FIGS. 3 and 4, the insulative body 1 comprises a base portion 11 and a tongue portion 12 integrally and forwardly extending from the base portion 11 into the receiving space 30.

Referring to FIGS. 3 and 4, each contact 2 comprises a contacting portion 21 extending beyond the tongue portion 12 and into the receiving space 30, a retaining portion 22 extending backwardly from the contacting portion 21 for being retained in the base portion 11, and a soldering portion 23 extending backwardly from the retaining portion 22 for being exposed outside of the insulative body 1. The soldering portions 23 are used for being soldered with the printed circuit board 6.

Referring to FIGS. 3 and 4, the metal shell 3 is tubular and comprises a top wall 31, a bottom wall 32, and a pair of sidewalls 33 connecting between the top wall 31 and the bottom wall 32. The receiving space 30 is defined between the top wall 31, the bottom wall 32, and the sidewalls 33. The metal shell 3 further comprises a pair of arc portions 34 at a rear edge thereof for securing with the insulative body 1. The metal shell 3 defines a pair of notches 35 on the top wall 31 for engaging with a pair of latches (not shown) of a mating plug connector (not shown).

Referring to FIGS. 3, 4, and 5, the metal plate 4 is frame shaped and is laser soldered to the metal shell 3. The metal plate 4 comprises a main portion 41, a plurality of fixing legs 42 extending laterally and downwardly from the main portion 41, and a cap portion 43 extending backwardly and downwardly from the main portion 41. The cap portion 43 is formed by locally drawing after a stamping process. The main portion 41 has a pair of bulges 411. The bulges 411 are formed by locally drawing after a stamping process, too. The bulges 411 protrude upwardly from the main portion 41 to cover the notches 35 for preventing water, dust, etc from entering into interior of an electrical appliance (not shown) which the electrical connector 100 is assembled on, through the notches 35. The cap portion 43 has an upper face 431, a pair of lateral faces 432, and a rear face 433. The upper face 431 is integrated with the main portion 41 in a front-and-rear direction. The lateral faces 432 are integrally connected with the upper face 431 in a vertical direction perpendicular to the front-and-rear direction. The rear face 433 is integrally connected with the lateral faces 432 and the rear face 433 in a transverse direction perpendicular to both the front-and-rear direction and the vertical direction. Therefore, the cap portion 35 suspends over the soldering portions 23 of the contacts 2 for providing protection to the soldering portions 23 of the contacts 2. Furthermore, because the cap portion 35 is seamless, EMI (Electro Magnetic Interference) is prevented to the soldering portions 23 of the contacts 2.

Referring to FIGS. 1-5, the insulative cover 5 comprises an upper wall 51, a lower wall 52, a pair of lateral walls 53 connecting between the upper wall 51 and the lower wall 52, and a rear wall 54 connecting between the upper wall 51, the lower wall 52, and the lateral walls 53. The rear wall 54 defines a slot 541 and the insulative body 1 is partly exposed into the slot 541.

A front edges of each lateral face 432 of the cap portion 43 is spaced away from a rear edge of the insulative cover 5 for a first interspace 71 along the front-and-rear direction. Each lateral face 432 of the cap portion 43 is spaced away from the adjacent insulative cover 5 for a second interspace 72 along the transverse direction. The first interspace 71 and the second interspace 72 are communicated with each other and are both communicated with the slot 541. The first interspace 71 and the second interspace 72 are respectively used for inserting a first mold (not shown) and a second mold (not shown) to orientate the insulative body 1 through the slot 541. Therefore, the insulative body 1 is partly exposed out of the insulative cover 5 after the first mold and the second mold are removed.

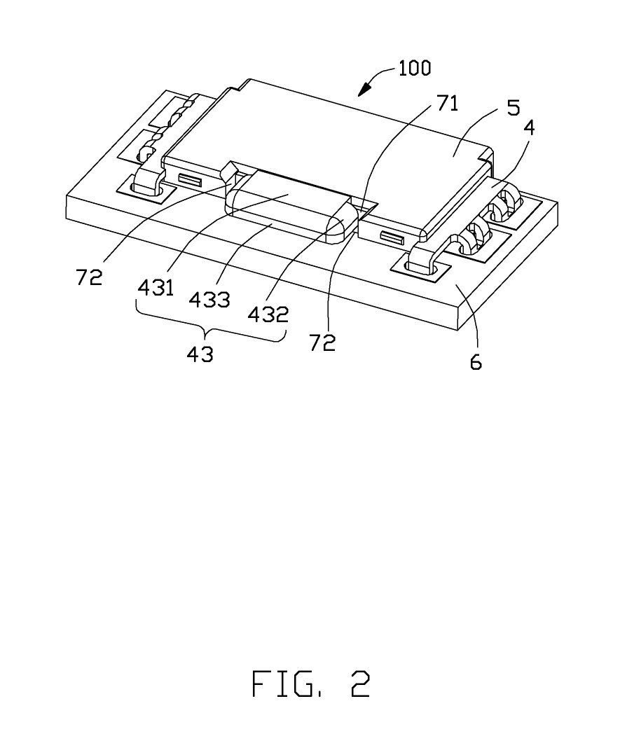

Referring to FIGS. 2, 3, and 5, when the electrical connector 100 is assembled on the printed circuit board 6, the electrical connector 100 is partly located above the printed circuit board 6 and partly located below the printed circuit board 6 such that the electrical connector 100 is so-called sink-type electrical connector for effectively using a space below the printed circuit board 6. The soldering portions 23 of the contacts 2 are SMT (Surface Mounted Technology) soldered to the printed circuit board 6. A bottom edge of the cap portion 43 is spaces away from the printed circuit board 6 for a third interspace 73 along the vertical direction for facilitating soldering operation of the soldering portions 23 of the contacts 2.

The cap portion 43 of the electrical connector 100 of the present invention is formed by locally drawing after a stamping process, therefore, the cap portion 43 is seamless connected between each two adjacent parts thereof, such as between the lateral faces 432 and the upper face 431, the rear face 433 and the upper face 431, and as well as the rear face 433 and the lateral faces 432. EMI (Electro Magnetic Interference) is prevented to the soldering portions 23 of the contacts 2 because of the seamless cap portion 43.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector for assembling on a printed circuit board, comprising:
an insulative body;
a metal shell covering the insulative body for defining a receiving space;
a plurality of contacts retained in the insulative body, each contact comprising a contacting portion extending into the receiving space, a retaining portion extending backwardly from the contacting portion for being retained with the insulative body, and a soldering portion extending backwardly from the retaining portion and outside of the insulative body; and
a metal plate having a main portion fixed to the metal shell and a seamless cap portion extending backwardly, downwardly from the main portion and suspending over the soldering portions of the contacts for providing protection, the cap portion having an upper face, a pair of lateral faces, and a rear face; wherein
the upper face is integrated with the main portion in a front-and-rear direction, the lateral faces are integrally connected with the upper face in a vertical direction perpendicular to the front-and-rear direction, and the rear face is integrally connected with the lateral faces and the rear face in a transverse direction perpendicular to both the front-and-rear direction and the vertical direction.

2. The electrical connector as claimed in claim 1, wherein the cap portion is formed by locally drawing after a stamping process.

3. The electrical connector as claimed in claim 2, wherein the main portion has a pair of bulges formed by locally drawing after a stamping process.

4. The electrical connector as claimed in claim 3, wherein the metal shell defines a pair of notches and the bulges protrude upwardly from the main portion to cover the notches.

5. The electrical connector as claimed in claim 1, further comprising an insulative cover insert-molded over the insulative body, the contacts, the metal shell, and the metal plate, and wherein the insulative body is partly exposed out of the insulative cover.

6. The electrical connector as claimed in claim 5, wherein the insulative cover comprises an upper wall, a lower wall, a pair of lateral walls connecting between the upper wall and the lower wall, and a rear wall connecting between the upper wall, the lower wall, and the lateral walls, the rear wall defines a slot, and the insulative body is partly exposed in the slot.

7. The electrical connector as claimed in claim 6, wherein a front edge of each lateral face of the cap portion is spaced apart from a rear edge of the insulative cover for a first interspace along the front-and-rear direction and each lateral face of the cap portion is spaced apart from the adjacent insulative cover for a second interspace along the transverse direction, and the first interspace and the second interspace are communicated with each other and are both communicated with the slot.

8. The electrical connector as claimed in claim 7, wherein the first interspace and the second interspace are formed by removing a first mold and a second mold respectively used for orientating the insulative body.

9. The electrical connector as claimed in claim 1, wherein a bottom edge of the cap portion is spaced from the printed circuit board for a third interspace along a vertical direction.

10. An electrical connector assembly comprising:
a terminal module including a plurality of contacts integrally formed within an insulative housing via a first insert molding process;
a metallic shell fixedly enclosing said terminal module and defining a mating port therein;
a metal plate soldered upon the shell; and
an insulative cover integrally formed upon the assembled terminal module, shell and plate via a second insert-mold process; wherein
the plate includes a plurality of legs exposed outside of the cover for mounting to a printed circuit board.

11. The electrical connector assembly as claimed in claim 10, wherein said plate further includes a cap portion shielding horizontal tails of the contacts in a vertical direction, a transverse direction and a front-to-back direction perpendicular to one another.

12. The electrical connector assembly as claimed in claim 10, wherein said insulative housing includes a vertical base portion through which the tails of the contacts rearwardly extend, and said base portion is partially covered by the cover and partially exposed rearwradly to an exterior.

13. The electrical connector assembly as claimed in claim 10, wherein the printed circuit board defines a notch, and the cover associated with the assembled terminal module, shell and plate, is received within said notch.

14. The electrical connector assembly as claimed in claim 10, wherein the legs of the plate downwardly extend not beyond a bottom face of the cover.

15. A method of making an electrical connector, comprising steps of:
providing a terminal module with a plurality of contacts within an insulative housing via a first insert-molding process;
securing a metallic shell upon the terminal module to define a mating port;
providing a metallic plate with mounting legs for mounting to a printed circuit board;
securing the metallic plate upon the shell;
applying an insulative cover over the shell via a second insert molding process.

16. The method as claimed in claim 15, wherein said contacts includes a plurality of tails horizontal extending rearwardly out of a base portion of said housing, and said base portion is partially covered by the cover and partially rearwardly exposed to an exterior.

17. The method as claimed in claim 16, wherein said plate further includes a cap enclosing said horizontal tails in a vertical direction, a transverse direction and a front-to-back direction perpendicular to one another.

18. The method as claimed in claim 15, wherein said mounting legs extend downwardly not beyond a bottom face of the cover.
